(19) United States
(12) Patent Application Publication
(10) Pub. No.: US 2022/0009785 A1
(43) Pub. Date: Jan. 13, 2022

(54) AQUEOUS SILICA DISPERSION WITH LONG SHELF LIFE FOR FIRE-RESISTANT GLASS

(71) Applicant: EVONIK OPERATIONS GMBH, Essen (DE)

(72) Inventors: Fulvio COSTA, Frankfurt am Main (DE); Maximilian CORNELIUS, Frankfurt am Main (DE); Gabriele BERGMANN, Grosskrotzenburg (DE); Corinna HENTSCHEL, Hanau (DE)

(73) Assignee: EVONIK OPERATIONS GMBH, Essen (DE)

(21) Appl. No.: 17/297,464

(22) PCT Filed: Jun. 5, 2019
(86) PCT No.: PCT/EP2019/064654

§ 371 Date: May 27, 2021

(30) Foreign Application Priority Data
Nov. 29, 2018 (EP) 18209216.3

(51) Int. Cl. C01B 33/141; C09K 21/02

(52) U.S. Cl. CPC C01B 33/1417; C09K 21/02; B82Y 40/00; C01P 2004/62; C01P 2004/64; C01P 2006/12

(57) ABSTRACT

The invention relates to aqueous silica dispersion with a pH in the range from 8 to 14, comprising a base chosen from the group consisting of alkali metal hydroxides, (akyl)ammonium hydroxides or a mixture thereof, at least 35% by weight of silica particles surface-treated with an amino-organosilane (I) and/or a product of hydrolysis of compound of formula (I), 3% to 35% by weight of at least one polyol, 20% to 60% by weight of water, preparation of such dispersion and the use thereof in fire-resistant glass.

The invention relates to aqueous silica dispersion, manufacturing process thereof, and its use in transparent heat protection elements like fire-resistant glasses.

Transparent heat protection elements, particularly fire-resistant glasses, serve in construction elements like windows and doors, which may provide protection against heat irradiation and flame as well as spreading of fire in emergency cases.

U.S. Pat. No. 2,340,837 discloses thermally insulating transparent laminated glass consisting of at least two sheets of glass comprising an interlayer with a thickness of 0.3 to 10 mm of a solid aqueous alkali metal silicate, containing from 10 to 40 percent of water, between the glass sheets. Under the influence of heat, for example in the event of fire, the alkali silicate foams and the water contained in the interlayer vaporises. This foam may serve for considerable period as a protective layer against undesired heat transmission. Although at least one of the glass plates cracks and breaks, the parts of the broken glass adhere to the built foam layer.

U.S. Pat. No. 5,565,273 describes a similar to that disclosed in U.S. Pat. No. 2,340,837 system with an interlayer containing a cured but not dried polysilicate formed from an alkali silicate, at least 44 percent water and a curing agent like colloidal or precipitated silicic acid.

U.S. Pat. No. 6,479,156 B1 discloses preparation of a nanocomposite comprising (A) at least 35 wt % of an inorganic material, particularly fumed silica with particle size of up to 200 nm, (B) 10-60 wt % of at least one compound containing two functional groups like polyols, e.g. glycerine, alkanolamines or polyamines, (C) 1-40 wt % water and (D) 0-10 wt % of an additive. Surface untreated fumed silica Aerosil® OX 50 or polyol-modified silica nanoparticles are shown to be used for preparation of such nanocomposites of U.S. Pat. No. 6,479,165 B1, which can be employed for manufacturing transparent insulation glass assemblies.

WO 2006002773 A1 discloses an aqueous silica dispersion, having pH of between 10 and 12 and comprising at least 35 wt % of silicon dioxide powder, particularly pyrogenically prepared surface-untreated silica like Aerosil® OX 50 with an average aggregate diameter of the silica particles of less than 200 nm, 3 to 35 wt % of at least one polyol, 20 to 60 wt % water and 0 to 10 wt %, preferably 0 wt % of an additive like biocides or dispersing auxiliaries. This silica dispersion can be used in transparent insulating glass arrangements.

An important issue during the preparation of fire-resistant glasses is that of avoiding gas in the used dispersion, which is usually achieved by degassing of this dispersion before assembly of a fire-resistant glass. If the gas is not properly eliminated, gas bubbles would appear in the fire-resistant glass, making it not suitable for use. It turns out, that the problem of gas bubble formation may also appear after the storage of the degassed silica dispersions. Thus, currently used fumed silica dispersions have a limited shelf life of several months. The use of such silica dispersions after expiration of this time can lead to fire-resistant glasses of lower quality. This is a serious limitation in use of such dispersions, as relatively long transportation or storage times may lay between the production of such silica dispersions and their end-use.

A similar problem is associated with the preparation of silica dispersions from the fumed silica, which has been stored for a longer time after its manufacturing. It has been found that preparation of silica dispersions for fire-resistant glasses from the older samples of fumed silica leads to lower quality of the final product due to gas bubble formation. Fumed silica material is known to undergo some change of its properties over the longer time of storage. Thus, J. Mathias and G. Wannemacher describe in Journal of Colloid and interface Science, Vol, 125 No 1 (1988), pp. 61-68 the difference between the density of hydroxyl-group in a freshly manufactured and stored for 1 year samples.

The problem addressed by the present invention is that of providing a silica dispersion for use in transparent heat protection elements like fire-resistant glasses, which has prolonged shelf life and can be manufactured from freshly prepared fumed silica material as well as from that after a long storage time.

The invention provides aqueous silica dispersion comprising
at least 35% by weight of silica particles surface-treated with an organosilane,
3% to 35% by weight of at least one polyol,
20% to 60% by weight of water,
a base chosen from the group consisting of alkali metal hydroxides, amines, amino alcohols, (akyl)ammonium hydroxides or a mixture thereof,

wherein the organosilane is a compound of formula (I) and/or a product of hydrolysis of compound of formula (I):

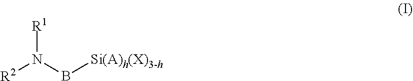

0≤h≤2

Si(A)ₕ(X)₃₋ₕ is a silane functional group,

A is H or a branched or unbranched C1 to C4 alkyl residue, preferably A is H, CH₃ or C₂H₅,

X is selected from Cl or a group OY, wherein Y is H or a C1 to C30 branched or unbranched alkyl-, alkenyl-, aryl-, or aralkyl-group, branched or unbranched C2 to C30 alkylether-group or branched or unbranched C2 to C30 alkylpolyether-group or a mixture thereof. Preferably, X is Cl, OCH₃ or OC₂H₅,

B is a branched or unbranched, aliphatic, aromatic or mixed aliphatic-aromatic C1 to C30 group, which may contain N, O and/or S heteroatoms, preferably is B a C1 to C6 carbon-based group, most preferably B is —(CH₂)₃— group,

each of R¹ and R² is independently H or branched or unbranched, aliphatic, aromatic or mixed aliphatic-aromatic C1 to C30 carbon-based group

and wherein

the pH of the dispersion is in the range from 8 to 14.

The term “carbon-based group” in the context of the present invention relates to a residue, containing carbon and hydrogen atoms, which may optionally contain some heteroatoms, such as N (nitrogen), O (oxygen) and S (sulfur). These heteroatoms may be incorporated in the main or side-chain of carbon-based group.

The terms “silica” and “silicon dioxide” are used as analogues in the present patent application. The origin of the silica particles employed in the present invention is not decisive. Thus, for example, colloidal silica, silicon dioxide prepared by precipitation or by pyrogenic processes also known as fumed silica can be present in the dispersion. However, it has been found that pyrogenically prepared silica, also known as fumed silica can advantageously be employed.

Pyrogenically prepared silica is generally understood as meaning silica particles which are obtained from a silicon precursor by a flame hydrolysis or flame oxidation in an oxyhydrogen flame. In such a process, one or more silicon compounds such as silicon tetrachloride or octamethylcyclotetrasiloxane (D4) are reacted in a flame generated by the reaction of hydrogen and oxygen. The thus obtained powder is referred to as “pyrogenic” or “fumed” silica. The reaction initially forms highly disperse approximately spherical primary silica particles, which in the further course of the reaction coalesce to form aggregates. The aggregates can then accumulate into agglomerates. In contrast to the agglomerates, which as a rule can be separated into the aggregates relatively easily by introduction of energy, the aggregates are broken down further, if at all, only by intensive introduction of energy. Said silica powder may be partially destructed and converted into the nanometre (nm) range particles advantageous for the present invention by suitable grinding.

In the present invention, the BET surface area of silica can be from 5 m²/g to 500 m²/g, preferably from 20 m²/g to 100 m²/g, particularly preferably from 30 m²/g to 60 m²/g. The BET surface area can be determined according to DIN 9277:2014 by nitrogen adsorption according to Brunauer-Emmett-Teller procedure.

The choice of polyol in the aqueous silica dispersion according to the present invention is not particularly limited. Preferably, such a polyol is well soluble in water or mixable with water. Suitable polyols can particularly be glycerol, ethylene glycol, trimethylolpropane, pentaerythritol, sorbitol, polyvinyl alcohol, polyethylene glycol or a mixture thereof. Glycerol is particularly preferred in this context.

The aqueous silica dispersion according to the invention comprises a base chosen from alkali metal hydroxides, amines, amino alcohols, (alkyl)ammonium hydroxides or a mixture thereof. Such a base helps to adjust a basic pH (pH≥8) of the aqueous silica dispersion of the present invention. Preferably, this base is well soluble in the liquid mixture of water and polyol. Examples of suitable amines are primary amines such as methylamine, secondary amines such as dimethylamine, tertiary amines such as trimethylamine. An example of quaternary (alkyl)ammonium hydroxides is tetramethylammonium hydroxide. Example of amino alcohols is ethanolamine. Preferably, the base is selected from the group consisting of potassium hydroxide, sodium hydroxide, lithium hydroxide and the mixture thereof. Potassium hydroxide (KOH) is particularly preferred as a base.

The aqueous silica dispersion of the invention has a pH of from 8 to 14, preferably from 9 to 13, more preferably from 10 to 13, even more preferably from 10.5 to 12.5.

The silica particles in the aqueous dispersion of the invention preferably have a number median particle diameter d₅₀ of less than 500 nm, more preferably less than 300 nm, even more preferably less than 200 nm, still more preferably from 30 nm to 200 nm. The number median particle diameter can be determined with dynamic light scattering method (DLS) directly in the aqueous dispersion of the present invention. The silica particles may be in the form of isolated individual particles and/or in the form of aggregated particles. In the case of aggregated particles, e.g. fumed silica particles, the number median particle diameter refers to the dimension of the aggregates.

The aqueous silica dispersion according to the invention, preferably comprises from 1 mmol to 60 mmol, more preferably from 2 mmol to 50 mmol, more preferably from 3 mmol to 40 mmol of the organosilane of formula (I) and/or the products of hydrolysis of compound of formula (I) and/or the units derived from the organosilane of formula (I) per 100 g of the dispersion. The units derived from the organosilane of formula (I) can be those formed by partial or complete hydrolysis of the organosilane, its reaction with the silanol groups on the surface of silica or other reactions taking place after adding the organosilane of formula (I) to an aqueous silica dispersion containing the polyol.

The aqueous silica dispersion of the present invention comprises silica, which is surface-modified by treating silica with an organosilane of formula (I) and/or a product of hydrolysis of compound of formula (I). Carbon content of such surface-treated silica particles may be from 0.2% to 20% by weight, more preferably from 0.5% to 15% by weight, even more preferably from 1% to 10% by weight. The carbon content can be determined by elemental analysis.

Particularly preferably, the aqueous silica dispersion according to the invention comprises
38% to 60% by weight of pyrogenically prepared silica surface-treated with an organosilane of formula (I) and/or a product of hydrolysis of compound of formula (I) and having a BET surface area of 30 m²/g to 60 m²/g,
5% to 25% by weight of glycerol,
25% to 50% by weight of water,
0.3% to 0.7% by weight of KOH.

Any impurities of the starting substances and substances formed during the preparation of the dispersion can be present in the aqueous dispersion of the invention. In particular, dispersions of pyrogenically prepared silica have an acidic pH as a result of the preparation, due to adhering residues of hydrochloric acid. These hydrochloric acid residues are for example neutralized to potassium chloride if KOH is added to the dispersion.

The organosilane of formula (I) and/or a product of hydrolysis of compound of formula (I) can particularly be chosen from 3-aminopropyltri-ethoxysilane (AMEO), 3-aminopropyltri-methoxysilane (AMMO), 3-aminopropyl-methyl-diethoxysilane, N-(2-aminoethyl)-3-aminopropyltriethoxysilane, N-(2-aminoethyl)-3-aminopropyltrimethoxysilane, aminoethylaminopropylmethyldimethoxysilane, 4-aminobutyltriethoxysilane, 4-amino-3,3-dimethylbutyltrimethoxysilane, 3-aminopropyltris(methoxyethoxyethoxy)silane, 11-aminoundecyltriethoxysilane, 3-aminopropylsilanetriol, 4-amino-3,3-dimethylbutylmethyldimethoxysilane, 1-amino-2-(dimethylethoxysilyl)propane, 3-aminopropyldiisopropylethoxysilane, 3-aminopropyldimethylethoxysilane, (aminoethylaminomethyl)phenethyltrimethoxysilane, n-(2-aminoethyl)-3-aminopropyltrimethoxysilane, N-(6-aminohexyl)aminomethyltriethoxysilane, n-(6-aminohexyl)aminopropyltrimethoxysilane, N-(2-aminoethyl)-11-aminoundecyltrimethoxysilane, n-3-[(amino(polypropylenoxy)]aminopropyltrimethoxysilane, N-(2-aminoethyl)-3-aminopropylsilanetriol (oligomers), N-(2-aminoethyl)-3-aminoisobutylmethyldimethoxysilane, N-(2-aminoethyl)-3-aminopropylmethyldiethoxysilane, N-(2-aminoethyl)-3-aminopropylmethyldimethoxysilane, N-(2-aminoethyl)-3-aminoisobutyldimethylmethoxysilane, (3-trimethoxysilylpropyl)diethylenetriamine, bis-(trimethoxysilylpropyl)amin, bis-(triethoxysilylpropyl)amin, products of hydrolysis thereof and mixtures thereof.

Additionally to compounds of formula (I) and/or products of hydrolysis thereof, the aqueous silica dispersion of the invention may contain other silanes, e.g. such as 1-(3-(triethoxysilyl)propyl)-2,2-diethoxy-1-aza-2-silacyclopentan.

Preferably, in the organosilane of formula (I) R¹═R²═H that is, organosilane of formula (I) is an amino silane, containing a terminal primary amino group.

Particularly preferably, the organosilane of formula (I) and/or a product of hydrolysis of compound of formula (I) is chosen from the group consisting of 3-aminopropyl triethoxysilane (AMEO), 3-aminopropyl trimethoxysilane (AMMO), 3-aminopropyl-methyl-diethoxysilane, N-(2-aminoethyl)-N′-(3-(trimethoxysilyl)propyl)ethylenediamine (TRIAMO), products of hydrolysis thereof and mixtures thereof.

The products of hydrolysis of compounds of formula (I) may comprise organosilanols, i.e. the compounds of formula (I) with at least one group X═OH, organosiloxanes, comprising one or multiple Si—O—Si bonds or mixtures of such compounds. An example of such products of hydrolysis, also known as hydrolysates, is Dynasylan® HYDROSIL 1153, an aqueous 3-aminopropylsilane hydrolysate manufactured by Evonik Resource Efficiency GmbH.

The aqueous silica dispersion according to the invention can further comprise additives in the form of biocides or dispersing auxiliaries. For many uses, however, these additives may prove to be a disadvantage, so that it may be advantageous if the dispersion according to the invention comprises no such additives.

The aqueous silica dispersion of the present invention is generally stable, that is this dispersion shows no noticeable sedimentation within a period of time of at least one month, as a rule at least 3 months. Therefore, the dispersion can be employed during this period of time without further filtration steps. Furthermore, no or only a minimal increase in the viscosity is generally observed within this period of time. This means that within this period of time the aqueous silica dispersion retains its property of being easily pourable at room temperature.

The invention provides a process for the preparation of the aqueous silica dispersion according to the invention, in which a dispersion comprising
at least 35% by weight of surface-untreated silica powder,
3% to 35% by weight of at least one polyol,
20% to 60% by weight of water is treated with

0.05% to 10% by weight related to the resulting aqueous dispersion of an organosilane of formula (I) and/or a product of hydrolysis of compound of formula (I).

The invention further provides another process for the preparation of the aqueous silica dispersion according to the invention, in which silica surface-treated with an organosilane of formula (I) and/or a product of hydrolysis of compound of formula (I) is mixed with water and the polyol.

Particularly, both processes of the invention can be performed as follows:
water, at least one polyol and optionally an additive are circulated from a reservoir, via a rotor-stator machine in an amount corresponding to the composition desired later, and
the amount of surface-untreated silica, silica surface-treated with an organosilane of formula (I) and/or a product of hydrolysis of compound of formula (I) or a mixture thereof, desired for the dispersion is introduced via a filling device, continuously or discontinuously and with the rotor-stator machine running, into the shearing zone between the slits of the rotor teeth and the stator slits,
the filling device is closed and dispersing is carried out further until the current uptake of the rotor-stator machine is largely constant, and
an amount of a base, e.g. KOH such that a pH of the dispersion of preferably 10≤pH≥13 results is then added, the base being added so rapidly that no gel formation takes place, and optionally
0.05% to 10% by weight related to the weight of the resulting aqueous dispersion of an organosilane of formula (I) and/or a product of hydrolysis of compound of formula (I) is added.

Alternatively, the processes of the invention can be performed in the following way:
a mixture of water, at least one polyol, optionally an additive and surface-untreated silica, silica surface-treated with an organosilane of formula (I) and/or a product of hydrolysis of compound of formula (I) or a mixture thereof is initially introduced into the dispersing vessel in an amount corresponding to the composition desired later,
dispersing is carried out by means of a planetary kneader,
a base is then added in an amount such that a pH of the dispersion of preferably 10≤pH≤13 results, and
0.05% to 10% by weight related to the weight of the resulting aqueous dispersion of an organosilane of formula (I) and/or a product of hydrolysis of compound of formula (I) is added.

Preferably, aqueous base solutions with a concentration of 20% to 50% by weight are employed, potassium hydroxide solution being particularly preferred. In case if the surface-treated silica is used for preparing the dispersion according to the invention, it may be beneficial to add a base such as potassium hydroxide, before or during the dispersing.

The processes of the invention can also be carried out by a procedure in which the addition of the polyol takes place only after the dispersing of the silica powder and before the addition of the base.

The dispersion according to the invention can furthermore be obtained by a procedure in which at least two partial streams of the dispersion prepared as described above with a rotor-stator or planetary kneader are placed under a pressure of up to 3,500 kg/cm² and let down via a nozzle and the part streams are allowed to collide with one another.

Numerous methods of dispersing are available to those skilled in the art. To produce finely divided aqueous dispersions of metal oxide, apparatuses such as for example ultrasound probes, ball mills, stirred ball mills, rotor/stator machines, planetary kneaders/mixers or high-energy mills or combinations thereof are available. Thus, for example a preliminary silica dispersion may be prepared using a rotor-stator system, which in a subsequent step is subjected to further milling by means of a high-energy mill. This combination makes it possible, for example, to produce extra fine aqueous dispersions of silica having a particle diameter of 200 nm or less. In the case of a high-energy mill, a preliminary dispersion under high pressure is divided into two or more streams, which are then decompressed through a nozzle and impinge exactly on one another.

The invention also provides the use of the aqueous silica dispersion according to the invention as a component of a flame-retardant filling of hollow spaces between structural components, in particular between insulating glass arrangements.

In addition, the aqueous silica dispersion according to the invention can also be used as a component of a filling of hollow spaces between structural components of plastic, metal, wood, plaster board, fermacel, pressboard, ceramic and natural or artificial stone, as well as in electric cables, for fireproofing purposes.

It can also be employed as a coating composition for structural components and is suitable for the production of thermally and mechanically stable foams in the form of, for example, bulk goods or mouldings.

The aqueous silica dispersion according to the invention can also be used in a mixture with pigments or (organic or inorganic, for example fibrous, pulverulent or lamellar) coarser, non-nanoscale additives, such as, for example, mica pigments, iron oxides, wood flour, glass fibres, metal fibres, carbon fibres, sands, clays and bentonite, if the transparency of the material which can thereby be produced is not important.

### EXAMPLES

### Example 1: Dispersions Prepared with Aged Sample of Fumed Silica

Fumed silica (AEROSIL® OX50, BET=50 m²/g, manufacturer: Evonik Resource Efficiency GmbH) was stored for a period of over 4 years under ambient conditions (25° C., 1 atm) and then was used to prepare a silica dispersion with the following composition:

1037.2 g (33.15 wt. %) deionized water

538.2 g (17.20 wt. %) glycerin

1508.4 g (48.20 wt. %) fumed silica (AEROSIL® OX50 stored for more than 4 years at ambient conditions)

45.5 g (1.45 wt. %) KOH solution (30 wt. % KOH in deionized water).

Preparation of the dispersion was carried out substantially according to the procedure described in Example 1 of WO 2006002773 A1 but with smaller laboratory scale equipment. More specifically, 917.7 grams of deionized water and 226.2 grams of glycerin were introduced in a double wall high-grade steel mixing container cooled with line water. While mixing at approximately 2000 rpm with a Dispermat model AE-3M dissolver equipped with a 75 mm diameter dissolver wheel, 1508.4 g of AEROSIL® OX50 were manually added over a time of 20 minutes. The mixing was continued for another 15 minutes after which the solution was homogenized for 30 minutes at 7000 rpm with an IKA Ultra-Turrax T 50 Disperser equipped with a rotor-stator dispersion tool model S 50 N-G 45 G.

The batch size of the prepared dispersion was 3 kg. From this master batch, four identical samples (dispersion samples 1.1 to 1.4) each of 300 g were then taken.

### Example 1a (Comparative Example—Without Amino Silane)

A 250 mL wide neck glass bottle containing 300 g of dispersion sample 1.1 was placed on a magnetic stirrer and heated at 55° C. for 1 hour while stirring. Stirring speed was maintained as high as possible without causing magnetic stirring rod to jump. The sample was then cooled down to room temperature (25° C.) and stored at this temperature. Eight days later, 148 g of the sample were placed in a 250 mL polyethylene (PE) cup. While mixing at 490 rpm with a Heidolph R2R 5021 stirrer mounting a blade stirrer, 52 g of 50 wt. % KOH solution were added at once and the mixing was continued for another 10 minutes. The mixture was degassed in a rotary evaporator under vacuum for 12 minutes. In the first two minutes the absolute pressure was gradually reduced from atmospheric to 65 mbar and then it was maintained at 65 mbar for another 10 minutes. The water bath temperature was maintained at 50° C. for the whole period of 12 minutes. The milky mixture was then used to fill 5 small (10 mL) transparent glass bottles. The bottles were cured in an oven at 75° C. for 8 hours. After curing, the content of all the bottles was transparent and solid in appearance but showed many small bubbles.

Due to the presence of these air bubbles, the thus prepared cured product is not suitable for use in transparent fire resistant glasses.

### Example 1b (According to the Invention)

6.46 g of 3-aminopropyl trimethoxysilane (Dynasylan® AMMO, manufacturer Evonik Resource Efficiency GmbH) was slowly added to 300 g of the stirred dispersion sample prepared in example 1 (sample 1.2) at 25° C. Further treatment of the dispersion was exactly the same as described in example 1a.

After curing, the content of all the 10 mL bottles was transparent and solid in appearance. No air bubbles could be seen.

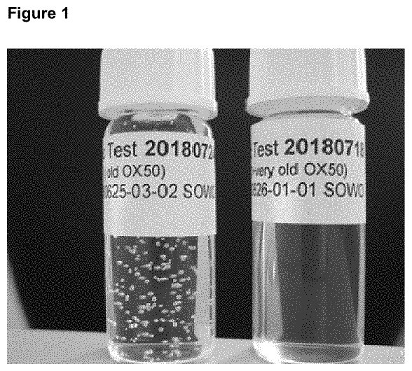

FIG. 1 shows the dispersion sample 1.1 (example 1a) without an amino silane (left) and dispersion sample 1.2 (example 1b) with AMMO (right).

### Example 1c (According to the Invention)

7.5 g of N-(2-aminoethyl)-N′-(3-(trimethoxysilyl)propyl)ethylenediamine (Dynasylan® TRIAMO, manufacturer Evonik Resource Efficiency GmbH) was slowly added to 300 g of the stirred dispersion sample prepared in example 1 (sample 1.2) at 25° C. Further treatment of the dispersion was exactly the same as described in example 1a.

After curing, the content of all the 10 mL bottles was transparent and solid in appearance. No air bubbles could be seen.

### Example 1d (According to the Invention)

5.0 g of N-(2-aminoethyl)-N′-(3-(trimethoxysilyl)propyl)ethylenediamine (Dynasylan® TRIAMO, manufacturer Evonik Resource Efficiency GmbH) was slowly added to 300 g of the stirred dispersion sample prepared in example 1 (sample 1.2) at 25° C. Further treatment of the dispersion was exactly the same as described in example 1a.

After curing, the content of all the 10 mL bottles was transparent and solid in appearance. No air bubbles could be seen.

### Example 1e (According to the Invention): The Effect of Treating Aged Fumed Silica with AMEO Before Preparation of Dispersion

AEROSIL® OX50 from the same batch as used in example 1 (stored for over four years) was treated with 3-aminopropyl triethoxysilane (Dynasylan® AMEO, manufacturer Evonik Resource Efficiency GmbH) following the procedure similar to that described in EP 0466958 A1. The AMEO-treated fumed silica was then used to make a silica dispersion with the following composition:

160.0 g (32.52 wt. %) deionized water,

89.7 g (17.36 wt. %) glycerin,

251.4 g (48.60 wt. %) AMEO-treated fumed silica,

7.58 g (1.47 wt. %) KOH solution (30 wt. % KOH in deionized water)

Preparation of the dispersion was carried out similarly to the procedure described in Example 1. More specifically, 153 grams of deionized water and 37.7 grams of glycerin were introduced in a double wall high-grade steel mixing container cooled with line water. While mixing at approximately 1700 rpm with a Dispermat model AE-3M dissolver equipped with a 75 mm diameter dissolver wheel, the first 90 g of the AMEO-treated AEROSIL® OX50 then 7.58 g of 30% KOH solution, and finally the remaining 161.4 g of AMEO-treated AEROSIL® OX50 were manually added. The mixing was continued for another 15 minutes after which the remaining 15 g of deionized water was added and the solution was homogenized for 45 minutes at 4000 rpm with an IKA Ultra-Turrax T 50 disperser equipped with a rotor-stator dispersion tool model S 50 N-G 45 G.

Further treatment of the dispersion was exactly the same as described in example 1a. After curing, the content of all of the 10 mL bottles was transparent and solid in appearance. No air bubbles could be seen.

As it can be seen from examples 1 and 1a, the use of aged fumed silica material in alkali silica dispersions containing glycerin may lead to a massive air bubble formation, which would preclude the use of such stored silica samples for preparing transparent fire resistant glasses. On the other hand, the use of particular amino silanes (examples 1b-1d) allow using of such aged fumed silica samples to prepare bubble-free silica dispersions suitable for use in transparent fire retardant glasses. The treatment of fumed silica with an amino silane can be carried out directly in the dispersion (examples 1b-1d) as well as separately, before forming the silica dispersion (example 1e).

### Example 2: The Effect of Adding AMEO to an “Old” Silica Dispersion

A silica dispersion was prepared with the following composition:

764 kg (31.30 wt. %) deionized water

397 kg (19.43 wt. %) glycerin

1125 kg (48.24 wt. %) fumed silica (AEROSIL® OX50, BET=50 m²/g, manufacturer: Evonik Resource Efficiency GmbH)

24.0 kg (1.03 wt. %) KOH solution (50 wt. % KOH in deionized water)

Preparation of the dispersion was carried out according to the procedure analogous to that described in Example 1 of WO 2006002773 A1 but on a larger scale.

The dispersion was stored for 1 year and 11 months at ambient conditions (25° C., 1 atm). After this storage time, two samples (dispersion samples 2.1 and 2.2) each of 300 g, were taken.

### Example 2a (Comparative Example)

A 250 ml PE cup containing 148 g of dispersion sample 2.1 was mixed with KOH solution (50 wt. % KOH in deionized water) in a mixing ratio of 74 wt. % silica dispersion/26 wt. % KOH solution. The mixture was degassed under vacuum for 12 minutes in a rotary evaporator for 12 minutes. In the first 2 minutes, the absolute pressure was gradually reduced from atmospheric to 65 mbar and then it was maintained at 65 mbar for 10 minutes. The water bath temperature was maintained at 50° C. for the whole period of 12 minutes. The milky mixture was then used to fill 4 small (10 mL) transparent glass bottles. The bottles were cured in an oven at 75° C. for 8 hours. After curing, the content of all the bottles was transparent and solid in appearance but showed many small bubbles.

Due to the presence of these air bubbles, the thus prepared cured product is not suitable for use in transparent fire resistant glasses.

### Example 2b (According to the Invention)

6.3 g of 3-aminopropyl triethoxysilane (Dynasylan® AMEO, manufacturer Evonik Resource Efficiency GmbH) was slowly added to 300 g of the stirred dispersion sample prepared in example 2 (dispersion sample 2.2) at 25° C. The dispersion sample was then heated to 55° C. for 1 hour while continuing to stir, then cooled down to 25° C. and stored at this temperature for 8 days. Further treatment of the dispersion was exactly the same as described in example 2a.

After curing, the content of all the 10 mL bottles was transparent and solid in appearance. No air bubbles could be seen.

As it can be seen from examples 2 and 2a, the use of aged alkali silica dispersions containing glycerin may lead to a massive air bubble formation, which would preclude the use of such stored silica dispersions in transparent fire resistant glasses. On the other hand, the use of amino silane AMEO (example 2b) allow using of such aged fumed silica dispersions to prepare bubble-free cured silica dispersions suitable for use in transparent fire retardant glasses.

### Example 3 (Comparative Example): The Effect of Ageing of a Reference Silica Dispersion on a Fire Resistant Windows

A silica dispersion was prepared with the following composition:

131.65 kg deionized water corresponding to 33.47 wt. %

67.73 kg (17.22 wt. %) glycerin

189.83 kg (48.26 wt. %) freshly prepared fumed silica (AEROSIL® OX50, BET=50 m²/g, manufacturer: Evonik Resource Efficiency GmbH).

4.14 kg (1.05 wt. %) KOH solution (30 wt. % KOH in deionized water)

Preparation of the dispersion was carried out according to the procedure described in Example 1 of WO 2006002773 A1.

The dispersion was then stored at ambient conditions (25° C., 1 atm). A first sample of this dispersion (sample 3.1) was taken after 11 days of storage, a second sample (sample 3.2) after 6 months of storage, and a third sample (sample 3.3) after 11 months of storage. Each sample was used to produce the fire-resistant interlayer in a fire-resistant glass windows of size 100 cm×100 cm.

The procedure used to prepare fire-resistant interlayer was as follows:

7.74 kg of the dispersion prepared in example 3 was placed in a double mantel mixing reactor equipped with temperature control and a vacuum pump which was capable of evacuating the empty reactor to an absolute pressure below 100 mbar. 2.76 kg of KOH solution (50 wt. % KOH in deionized water), were gradually added to the reactor while mixing (weight ratio of dispersion to KOH solution was 73.7:26.3, wt %:wt %). The mixture was degassed under vacuum for 15 minutes, while the temperature was maintained between 45° C. and 50° C., after which it was quickly cooled down to room temperature. The degassing was continued at room temperature (25° C.) for another 40 minutes after which the still fluid mixture was used to fill the cavity between two thermally tempered glass plates, which were pre-assembled together with suitable spacer sealant and spacer materials. The size of each glass plate was 100 cm×100 cm×5 mm and they were assembled together so that the two inner faces were 6 mm apart. The mixture was introduced through an opening in the sealant material. Once the space between the glass plates was filled, the opening in the sealant was sealed and the window was placed in horizontal position in a curing oven. The window was then heated at 75° C. for 15 hours. The results were as follows:

The window obtained with the dispersion sample stored for 11 days (sample 3.1) was clear, transparent and bubble-free.

The window obtained with the dispersion sample stored for 6 months (sample 3.2) was clear and transparent, but contained a few small bubbles.

The window obtained with the dispersion sample stored for 11 months (sample 3.3) was clear and transparent, but contained many bubbles.

### Example 4 (According to the Invention): The Effect of Ageing of a Silica Dispersion Containing AMEO on a Fire Resistant Windows

A silica dispersion was prepared with the following composition:

33.87 kg deionized water corresponding to 32.17 wt. %

17.94 kg (17.04 wt. %) glycerin

50.28 kg (47.75 wt. %) fresh fumed silica (AEROSIL® OX50, BET=50 m²/g, manufacturer: Evonik Resource Efficiency GmbH)

1.13 kg (1.05 wt. %) KOH solution (30 wt. % KOH in deionized water)

2.08 kg (1.98 wt. %) 3-aminopropyl triethoxysilane (Dynasylan® AMEO, manufacturer Evonik Resource Efficiency GmbH).

Preparation of the dispersion was carried out according to the procedure described in Example 1 of WO 2006002773 A1. While stirring, Amino silane (AMEO) was slowly added to the dispersion containing all other components The dispersion was heated and maintained at a temperature of 55° C. while stirring for 1 hour after which it was stored at ambient conditions. A first sample of this dispersion (sample 4.1) was taken after 11 days of storage, a second sample (sample 4.2) after 6 months of storage, and a third sample (sample 4.3) after 11 months of storage. Each sample was used to produce the fire-resistant interlayer in a fire-resistant glass windows of size 100 cm×100 cm. The same procedure for preparation of fire-resistant interlayer as described in example 3, was used.

The window obtained with the dispersion sample stored for 11 days (sample 4.1) was clear, transparent and bubble free.

The window obtained with the dispersion sample stored for 6 months (sample 4.2) was clear, transparent, and bubble free.

The window obtained with the dispersion sample stored for 11 months (sample 4.3) was clear, transparent, and still bubble free.

The examples 3 and 4 show that the results obtained in examples 2a and 2b on a 10 mL scale can be reproduced on a large scale, in real fire-resistant glasses. Examples 3 and 4 show that storage of a silica dispersion not containing an amino silane over the time of 11 days to 6 months could lead to a slight deterioration in quality of the prepared windows, whereas storage for 11 months leads to considerable air bubble formation and makes such dispersions not suitable for use in transparent fire-resistant windows.

### Example 5: Fire Test of Glass Plate Made with Silica Dispersion Containing AMEO

A window prepared as in example 4 was mounted in a frame and tested in a furnace. The furnace was heated according to the standard temperature curve defined in EN 1363-1. The window resisted 39.7 minutes of thermal treatment according to EN 1364-1 thereby achieving requirements for classification EI30.

1-15. (canceled)

16. An aqueous silica dispersion, comprising;
at least 35% by weight of silica particles surface-treated with an organosilane;
3% to 35% by weight of at least one polyol;
20% to 60% by weight of water;
a base chosen from the group consisting of alkali metal hydroxides, amines, amino alcohols, (akyl)ammonium hydroxides or a mixture thereof;
wherein the organosilane is a compound of formula (I) and/or a product of hydrolysis of compound of formula (I): 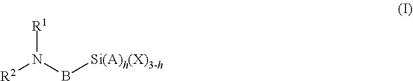
wherein:
0≤h≤2;
Si(A)ₕ(X)₃₋ₕ is a silane functional group;
A is H or a branched or unbranched C₁ to C₄ alkyl residue;
X is selected from Cl or a group OY, wherein Y is H or a C₁ to C₃₀ branched or unbranched alkyl-, alkenyl-, aryl-, or aralkyl-group, branched or unbranched C₂ to C₃₀ alkylether-group or branched or unbranched C₂ to C₃₀ alkylpolyether-group or a mixture thereof,
B is a branched or unbranched, aliphatic, aromatic or mixed aliphatic-aromatic C₁ to C₃₀ carbon-based group, which may contain N, S and/or O heteroatoms;
each of R¹ and R² is independently H or branched or unbranched, aliphatic, aromatic or mixed aliphatic-aromatic C₁ to C₃₀ carbon-based group; and
wherein the pH of the dispersion is in the range from 8 to 14.

17. The aqueous silica dispersion of claim 16, wherein the silica is a fumed silica.

18. The aqueous silica dispersion of claim 16, wherein the silica has a BET surface area of 30 m²/g to 60 m²/g.

19. The aqueous silica dispersion of claim 16, wherein the polyol is glycerol, ethylene glycol, trimethylolpropane, pentaerythritol, sorbitol, polyvinyl alcohol, polyethylene glycol or a mixture thereof.

20. The aqueous silica dispersion of claim 16, wherein the base is potassium hydroxide, sodium hydroxide or lithium hydroxide.

21. The aqueous silica dispersion of claim 16, wherein the number mean aggregate diameter of the silica particles in the dispersion is less than 200 nm.

22. The aqueous silica dispersion of claim 16, wherein the pH of the dispersion is in the range of 10 to 13.

23. The aqueous silica dispersion of claim 16, comprising from 1 mmol to 60 mmol of the organosilane of formula (I) and/or the units derived from the organosilane of formula (I) per 100 g of the dispersion.

24. The aqueous silica dispersion of claim 16, wherein said aqueous silica dispersion comprises 38% to 60% by weight of pyrogenically prepared silica surface-treated with an organosilane of formula (I) and/or a product of hydrolysis of compound of formula (I), and having a BET surface area of 30 m²/g to 60 m²/g;
5% to 25% by weight of glycerol,
25% to 50% by weight of water,
0.3% to 0.7% by weight of KOH.

25. The aqueous silica dispersion claim 16, wherein in the organosilane of formula (I):
0≤h≤2;
A is H, CH₃ or C₂H₅;
B is a branched or unbranched, aliphatic, aromatic or mixed aliphatic-aromatic C₁ to C₆ carbon-based group;
X is Cl, OCH₃ or OC₂H₅.

26. The aqueous silica dispersion of claim 16, wherein, in the organosilane of formula (I), R¹═R²═H.

27. The aqueous silica dispersion of claim 16, wherein the organosilane is chosen from the group consisting of 3-aminopropyl triethoxysilane (AMEO), 3-aminopropyl trimethoxysilane (AMMO), 3-aminopropyl-methyl-diethoxysilane, N-(2-aminoethyl)-N′-(3-(trimethoxysilyl)propyl)ethylenediamine (TRIAMO), products of hydrolysis thereof and mixtures thereof.

28. The aqueous silica dispersion of claim 27, wherein the polyol is glycerol, ethylene glycol, trimethylolpropane, pentaerythritol, sorbitol, polyvinyl alcohol, polyethylene glycol or a mixture thereof.

29. The aqueous silica dispersion of claim 28, wherein the base is potassium hydroxide, sodium hydroxide or lithium hydroxide.

30. The aqueous silica dispersion of claim 29, wherein the number mean aggregate diameter of the silica particles in the dispersion is less than 200 nm.

31. The aqueous silica dispersion of claim 28, wherein said aqueous silica dispersion comprises 38% to 60% by weight of pyrogenically prepared silica surface-treated with an organosilane of formula (I) and/or a product of hydrolysis of compound of formula (I), and having a BET surface area of 30 m²/g to 60 m²/g;
5% to 25% by weight of glycerol,
25% to 50% by weight of water,
0.3% to 0.7% by weight of KOH.

32. The aqueous silica dispersion of claim 28, wherein in the organosilane of formula (I)
0≤h≤2
A is H, CH₃ or C₂H₅,
B is a branched or unbranched, aliphatic, aromatic or mixed aliphatic-aromatic C₁ to C₆ carbon-based group,
X is Cl, OCH₃ or OC₂H₅.

33. The aqueous silica dispersion of claim 28, wherein, in the organosilane of formula (I), R¹═R²═H.

34. A process for the preparation of the aqueous silica dispersion of claim 16, wherein a dispersion, comprising:
at least 35% by weight of surface-untreated silica powder;
3% to 35% by weight of at least one polyol;
20% to 60% by weight of water is treated with
0.05% to 10% by weight relative to the weight of the resulting aqueous dispersion, of an organosilane of formula (I) and/or a product of hydrolysis of compound of formula (I).

35. A process for the preparation of the aqueous silica dispersion of claim 16, wherein the silica surface-treated with an organosilane of formula (I) and/or a product of hydrolysis of compound of formula (I) is mixed with water and the polyol.
